(19) United States
(12) Patent Application Publication
(10) Pub. No.: US 2010/0202086 A1
(43) Pub. Date: Aug. 12, 2010

(54) STORAGE DEVICE AND DESIGN METHOD THEREOF

(75) Inventor: Makoto Okamoto, Kawasaki-shi (JP)

Correspondence Address: KNOBBE MARTENS OLSON & BEAR LLP, 2040 MAIN STREET, FOURTEENTH FLOOR, IRVINE, CA, 92614, US

(73) Assignee: TOSHIBA STORAGE DEVICE CORPORATION, Tokyo (JP)

(21) Appl. No.: 12/753,029

(22) Filed: Apr. 1, 2010

Related U.S. Application Data
(63) Continuation of application No. PCT/JP2007/069168, filed on Oct. 1, 2007.

(51) Int. Cl. G11B 5/60

(52) U.S. Cl. 360/234.3; G9B/5.229

(57) ABSTRACT

According to one embodiment, a storage device includes a spindle assembly including a spindle motor configured to rotate a disk, and a clamp ring configured to fix the disk to the spindle motor, and a slider with a head configured to read/write data on/from the disk, and configured to fly over a surface of the rotating disk. The slider includes a trailing edge on a floating surface of the slider opposed to the disk, and the trailing edge is an end part through which an airflow exits. The spindle assembly and the slider are configured to satisfy a relationship of 0.95f≦F≦1.05f at a temperature of 23° C., where f is an anti-resonance frequency of the trailing edge, and F is a resonance frequency of the spindle assembly.

### CROSS REFERENCE TO RELATED APPLICATIONS

This is a Continuation Application of PCT Application No. PCT/JP2007/069168, filed Oct. 1, 2007, which was published under PCT Article 21(2) in Japanese.

### BACKGROUND

1. Field

One embodiment of the invention relates to a storage device and a design method of the same.

2. Description of the Related Art

In a hard disk drive (HDD), the head subjects the disk to read/write in a state where the slider is floated over the disk surface. When the disk is rotated, an airflow is produced, and the airflow produces lift configured to float the slider over the disk surface. A suspension configured to support the slider includes a protrusion, and applies elastic force opposed to the lift of the slider to the slider through the protrusion. The flying height of the slider is controlled by the balance between the lift and elastic force. On the floating surface of the slider opposed to the disk, an end part through which the airflow enters is referred to as a leading edge, and an end part through which the airflow exits is referred to as a trailing edge.

As described above, the slider is floated over the disk during read/write and is not fixed, and hence there occurs a problem that the slider collides with the disk surface due to external shock, and both of or one of the slider and disk surface is damaged. Regarding such a problem, Jpn. Pat. Appln. KOKAI Publication No. 2004-94989 (Patent Document) proposes a method for making the resonance frequency of the suspension and that of the disk coincident with each other.

The slider fluctuates around the protrusion of the suspension, and hence, if the resonance frequency of the suspension is used as the point of reference as described in the Patent Document, there is the possibility of the leading edge or trailing edge colliding with the disk surface. Further, the disk is fixed to a spindle motor by means of screws through a clamp ring, and the external shock is not directly applied to the disk, and is transmitted to the disk through the clamp ring and spindle motor. Accordingly, it is not reasonable to use the resonance frequency of the simplex disk as the point of reference without considering the influence of the clamp ring and spindle motor as described in the Patent Document. Furthermore, the resonance frequency of the simplex disk is far larger than the resonance frequency of the suspension, and it is therefore actually impossible to make both the resonance frequencies coincident with each other.

### BRIEF DESCRIPTION OF THE SEVERAL VIEWS OF THE DRAWINGS

A general architecture that implements the various features of the invention will now be described with reference to the drawings. The drawings and the associated descriptions are provided to illustrate embodiments of the invention and not to limit the scope of the invention.

FIG. 1 is an exemplary plan view showing the internal structure of a hard disk drive as an embodiment of the present invention;

FIG. 2 is an exemplary enlarged perspective view of a magnetic head section of the hard disk drive shown in FIG. 1;

FIG. 3 is an exemplary schematic cross-sectional view showing the relationship between a suspension shown in FIG. 1 and slider shown in FIG. 2;

FIG. 4 is an exemplary partial cross-sectional perspective view of the vicinity of a spindle motor shown in FIG. 1;

FIG. 5 is an exemplary schematic cross-sectional view of a clamp ring before being screwed;

FIG. 6 is a schematic cross-sectional view of a modification example of FIG. 4;

FIG. 7 is a graph showing the frequency response of the slider shown in FIG. 2 relating to the disk shown in FIG. 1; and

FIG. 8 is a flowchart for explaining a design method of the storage device of the embodiment of present invention.

### DETAILED DESCRIPTION

Various embodiments according to the invention will be described hereinafter with reference to the accompanying drawings. In general, according to an aspect of the invention, there is provided a storage device comprising a spindle assembly comprising a spindle motor configured to rotate a disk, and a clamp ring configured to fix the disk to the spindle motor; and a slider with a head configured to read/write data on/from the disk, and configured to fly over a surface of the rotating disk, the slider comprising a trailing edge on a floating surface of the slider opposed to the disk, the trailing edge being an end part through which an airflow exits, the spindle assembly and the slider being configured to satisfy a relationship of 0.95f≦F≦1.05f at a temperature of 23° C., where f is an anti-resonance frequency of the trailing edge, and F is a resonance frequency of the spindle assembly.

According to such a storage device, the anti-resonance frequency f of the trailing edge of the slider, and resonance frequency of the spindle assembly are substantially coincident with each other, and hence when there occurs an external shock, it becomes easy for the slider to follow up the displacement of the disk, and it becomes hard for both the slider and disk to collide with each other.

In order to reduce the damage from the collision in a case where a shock exceeding a permissible value is applied to the storage device, the resonance frequency of the spindle assembly may be made to be coincident not with the resonance frequency of the suspension, but with the anti-resonance frequency of the trailing edge of the slider. As a result of this, it becomes hard for the trailing edge to rise abruptly from the disk, and even if the leading edge side rises abruptly from the disk, the flotation stability of the slider is maintained, whereby it becomes hard for the slider to collide with the disk when the slider lands on the disk.

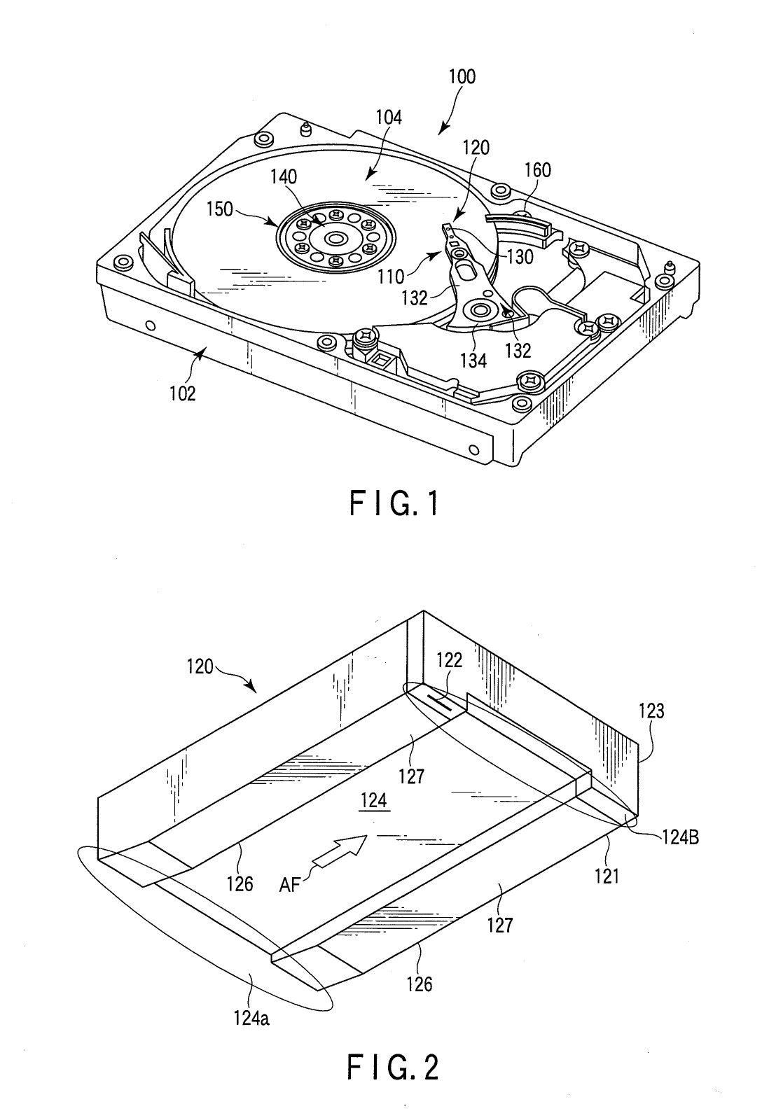

An HDD as a storage device according to an embodiment of the present invention will be described with reference to the accompanying drawings. FIG. 1 is an exemplary schematic plan view of the internal structure of the HDD 100. In the HDD 100, as shown in FIG. 1, one or a plurality of magnetic disks 104 serving as recording media, head stack assembly (HSA) 110, spindle motor 140, clamp ring 150, and ramp 160 are contained in a housing 102.

The housing 102 comprises, for example, a die-cast aluminum base, stainless steel or the like, has a rectangular parallelepiped-like shape, and a cover (not shown) configured to seal the internal space is coupled thereto. The magnetic disk 104 of this embodiment has a high surface recording density, for example, 100 Gb/in² or more. The magnetic disk 104 is attached to a spindle of the spindle motor 140 through a hole provided in the center thereof.

The HAS 110 includes a magnetic head section 120, suspension 130, and carriage 132.

FIG. 2 is an exemplary enlarged perspective view of the magnetic head section 120. As shown in FIG. 2, the magnetic head section 120 comprises a slider 121 formed into a substantially rectangular parallelepiped-like shape, and made of Al₂O₃—TiC (ALTiC), and a head element incorporation film 123 which is joined to the air trailing edge of the slider 121, is made of Al₂O₃ (alumina), and in which a head 122 for reading and writing is incorporated. A medium-opposed surface opposed to the magnetic disk 104, i.e., the floating surface 124 is defined on the slider 121 and head element incorporation film 123. The airflow AF produced on the basis of the rotation of the magnetic disk 104 is received by the floating surface 124.

Two rails 126 extending from the leading edge 124a to the trailing edge 124b are formed on the floating surface 124. A so-called air bearing surface (ABS) is defined on the top surface of each of the rails 126. Lift is produced on the ABS 127 in accordance with the action of the airflow AF. The head 122 embedded in the head element incorporation film 123 is exposed to the outside on the ABS 127.

In this embodiment, the head 122 is exemplarily an MR inductive combined head. The MR inductive combined head includes an inductive write head (hereinafter referred to as an “inductive head element” configured to write binary information to the magnetic disk 104 by utilizing a magnetic field arising in a conductive coil pattern (not shown), and magnetoresistance effect (hereinafter referred to as “MR”) head element configured to read binary information on the basis of resistance changing in accordance with a magnetic field acting from the magnetic disk 104.

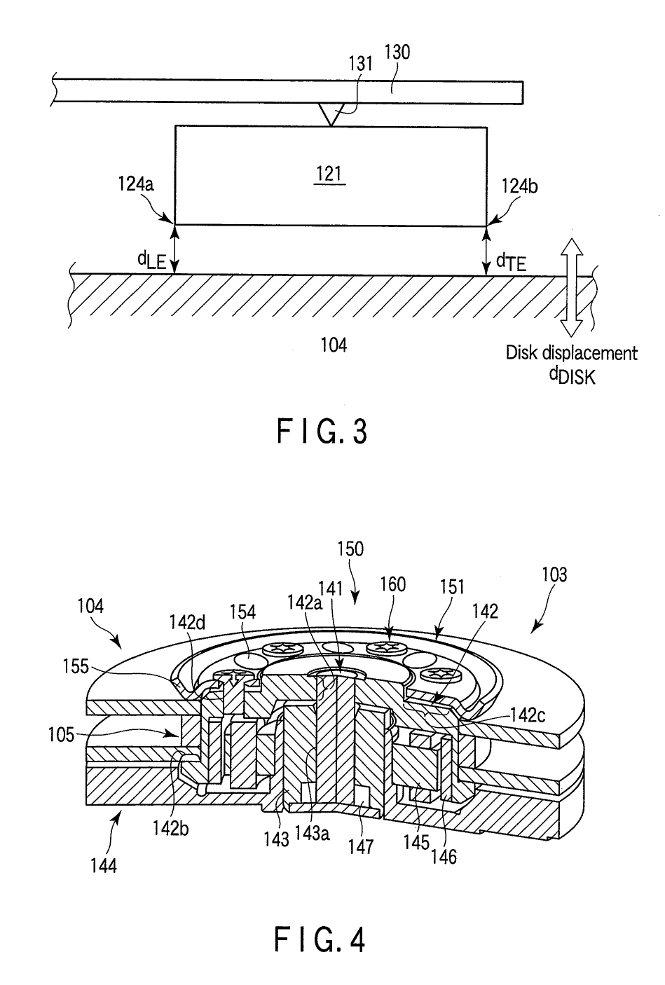

FIG. 3 is a schematic cross-sectional view showing a relationship between the suspension 130 and slider 121. The suspension 130 supports the magnetic head section 120, and includes a protrusion 131 configured to impart elastic force to the magnetic head section 120 against the magnetic disk 104. Further, the suspension 130 includes a flexure (referred to as a gimbal spring or by another name in some cases) configured to support the magnetic head section 120 by the cantilever method, and load beam (referred to as a load arm or by another name in some cases) to be connected to a base plate. Further, the suspension 130 also supports a wiring section (not shown) to be connected to the magnetic head section 120 through a lead wire or the like. Through such a lead wire, supply or output of a sense current, write information, or read information is carried out between the head 122 and the wiring section.

The carriage 132 is fluctuated around a pivot 134 by a voice coil motor (not shown). The carriage 132 has an actuator cross section of a substantial E-shape, and hence is also referred to as an E block or actuator (AC) block. A support section of the carriage 132 is referred to as an arm, and the arm is a rigid body which is made of aluminum, and is provided so that it can rotate or fluctuate around the pivot 134. The carriage 132 is further provided with a flexible circuit board (FPC) configured to supply a control signal, signal to be recorded on the disk 104, and power to the wiring section, and receive a signal reproduced from the disk 104.

FIG. 4 is an exemplary partial cross-sectional perspective view of the spindle motor. The spindle motor 140 rotates the magnetic disk 104 at a high speed of, for example, 10000 rpm. The spindle motor 140 includes, as shown in FIG. 4, a spindle 141, (spindle) hub 142, sleeve 143, bracket (base) 144, core 145, magnet 146, annular thrust plate 147, radial bearing, and lubricant (fluid). It should be noted that in this embodiment, the hub 142 is also used as a yoke. The hub 142 and spindle 141, or the spindle 141 and thrust plate 147 may be formed integral with each other.

The spindle 141 rotates together with the disk 104 and hub 142.

The hub 142 is fixed to the spindle 141 at an upper part 142a thereof, and supports the disk 104 by a flange 142b thereof. Further, the hub 142 includes an annular mounting surface 142c to which a main body 151 of the clamp ring 150 is attached on a top surface thereof. A plurality (six in this embodiment) of threaded holes 142d are formed in the mounting surface 142c. In this embodiment, although the number of the threaded holes 142d arranged at regular intervals in a concentric manner is six, in the present invention, the number of threaded holes 142d is not limited to six. Screws are attached to the threaded holes 142d.

The sleeve 143 is a member used to rotatably fit the spindle 141, and is fixed to the inside of the housing 102. While the spindle 141 rotates, the sleeve 143 does not rotate, and constitutes a fixing section together with the bracket 144. A groove (gap) 143a configured to introduce the lubricant to the sleeve 143 is formed in the sleeve 143. When the spindle 141 rotates, dynamic pressure (fluid pressure) is produced in the lubricant along the groove (radial bearing).

The bracket (base) 144 is fixed to the housing 102 around the sleeve 143, and supports the core (coil) 145, magnet 146, and yoke (not shown). As described above, the bracket 144 is fixed to the housing 102, and functions as a support section of the spindle motor 140. A current is made to flow through the core 145, and the core 145, magnet 146, and yoke serving also as the hub constitute a magnetic circuit. The magnetic circuit is used to fluctuate the head in opposition to the voice coil motor of the carriage. The thrust plate 147 is arranged at a central part of the sleeve at a lower end thereof, and constitutes a thrust bearing configured to support the weight of the spindle 141 in the longitudinal direction thereof. The radial bearing is a pressure bearing configured to support the spindle 141 in a noncontact manner through the lubricant, and is provided at two or more positions around the spindle 141 in the longitudinal direction of the spindle 141. The radial bearing supports the load of the spindle 141 in the radial direction.

The clamp ring 150 has a function of fixing the disk 104 and spacer 105 to the spindle motor 140. The spacer 105 is arranged between the two disks 104 adjacent to each other, and maintains the gap between the disks 104.

The clamp ring 150 is constituted of a main body 151 with an annular disk-like shape. The main body 151 is fixed to the hub 142 by means of screws 156, and includes a top surface 152, a plurality (six in this embodiment) of screw holes 153, a plurality (six in this embodiment) of stress relaxation holes 154, and disk pressure section 155.

In the six screw holes 153, the screws 156 used to fix the main body 151 to the hub 142 are inserted, and the holes 153 are arranged in the main body 151 at intervals of 60° in the circumferential direction of the main body 151. As shown in FIGS. 1 and 4, the screw-heads of the screws 156 are exaggerated as if the screw-heads of the screws 156 are positioned outside (i.e., on the top surface 152 of the main body 151) the screw holes 153. The six stress relaxation holes 154 are arranged at intervals of 60° between the six screw holes, and relax the deformation of the main body 151 occurring when the main body 151 is fixed to the hub 142 by means of the screws 156.

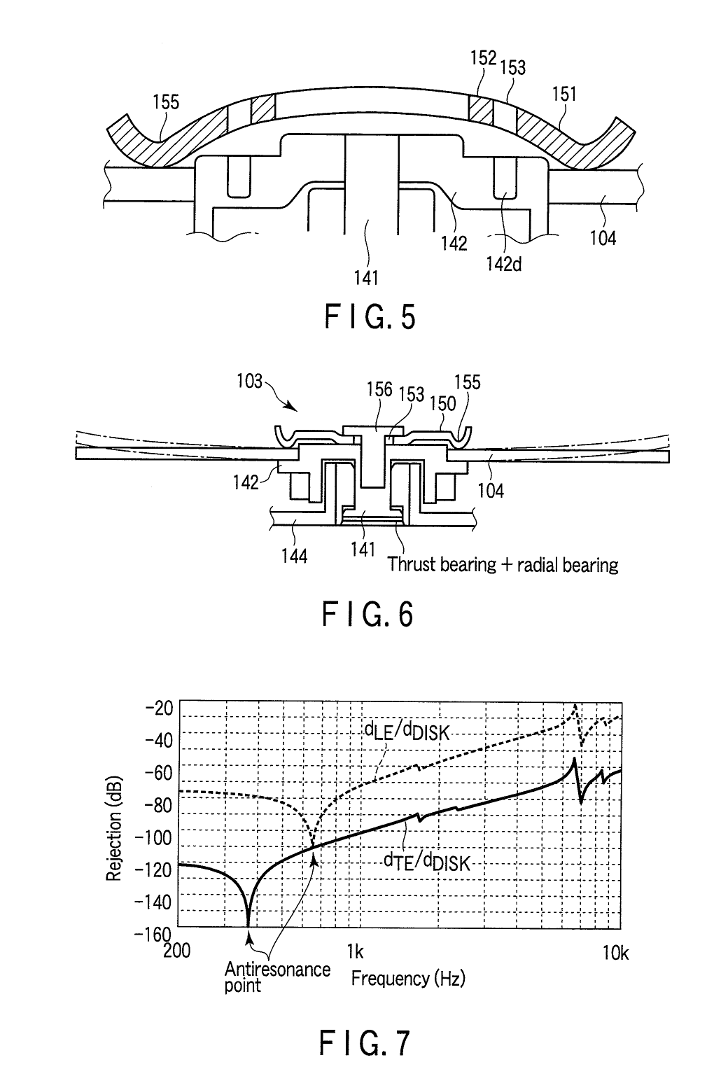

After the main body 151 is attached to the hub 142, the screw holes 153 and stress relaxation holes 154 are through holes extending substantially in parallel with the spindle 141. The reason for saying “after the main body 151 is attached” is that when the main body 151 before being screwed is placed on the disk 104 and hub 142 in a posture in which the main body 151 is to be fixed by the screws 156 as shown in FIG. 5, the main body has an upwardly convex mortar-like shape, and has a shape in which the inner circumferential side is more separate from the top surface of the hub 142 than the outer circumferential side in some cases. Here, FIG. 5 is a schematic cross-sectional view exaggerating the state before the main body 151 is screwed. Such an inclination is formed over the entire circumference of the main body 151, thereby imparting elastic force to the disk pressure section 155, and producing an effect of securing pressure on the disk 104. As described above, a certain amount of deformation of the main body 151 caused by the screwing of the screws 156 is expected. In this case, the periphery of the screw hole 153 tends to swell in the circumferential direction by receiving the load of the screws 156. In the case of six screw holes 153, six swells tend to occur in the circumferential direction of the main body 151. Such swells are reflected in the disk 104 through the disk pressure section 155. The stress relaxation holes 154 are configured to reduce such swells.

The disk pressure section 155 is an annular member provided on the lower periphery of the main body 151, and configured to press the disk 104. The stress relaxation holes 154 are provided inside the disk pressure section 155. The screws 156 fix the main body 151 to the hub 142 (spindle 141 in another embodiment). The screws 156 are screwed into the hub 142, thereby specifying the clamping force fixing the disk 104 to the hub 142. The seating face of the screw 156 presses the part on the main body around the screw hole 153 at which the screw 156 is in contact with the part around the screw hole 153, whereby the clamping force is transmitted to the pressure section 155.

The number of the screw holes 153 may be one. In this case, one screw hole 153 is provided in the center, the screw 156 is inserted therein, and the screw 156 is fixed to the spindle 141 as shown in FIG. 6. Here, FIG. 6 is a schematic cross-sectional view of a modification example of FIG. 4. Needless to say, in FIG. 6, although the number of the disk 104 is one, the number of the disks is not limited to this. In any case, when the disk pressure section 155 presses the disk 104, the disk 104 is deformed into a reverse umbrella-like shape as indicated by dotted lines in FIG. 6 (umbrella deformation mode).

A reference symbol 103 shown in FIGS. 3 and 6 denotes a spindle assembly. The spindle assembly 103 includes a disk 104, spindle motor 140, and clamp ring 150.

The ramp 160 is a member configured to be engaged with a distal end member (also referred to as a lift tab) of the suspension 130 at the non-operating time, and fasten the slider 121 outside the disk 104.

FIG. 7 is a graph showing the frequency response of the slider 121 shown in FIG. 3 at the leading edge 124a and trailing edge 124b. Here, d_{LE} indicates the displacement of the leading edge 124a, and d_{TE} indicates that of the trailing edge 124b. Further, d_{DISK} indicates the displacement of the disk 104. The dotted line indicates d_{LE}/d_{DISK}, and solid line indicates d_{TE}/d_{DISK}. The minimum position in each frequency responses is an antiresonance point, and is a point at which the leading edge 124a or the trailing edge 124b follows up the displacement of the disk 104 best. This embodiment is characterized in that the anti-resonance frequency f of the trailing edge 124b is made substantially equal to the resonance frequency F of the spindle assembly 103, i.e., relationship 1 is satisfied.

0.95f≦F≦1.05f (1)

Table 1 shows data of each frequency in a conventional magnetic disk apparatus including a 2.5-inch disk 104. The frequencies in Table 1 were calculated by using the finite element method.

TABLE 1

| | |
|---|---|
| Resonance frequency | approx. 401 Hz |
| of suspension 130 | |
| Anti-resonance frequency of | approx. 632 Hz |
| leading edge 124a of slider 121 | |
| Anti-resonance frequency of | approx. 360 Hz |
| trailing edge 124b of slider 121 | |
| Resonance frequency | approx. 1.8 kHz |
| of simplex disc 104 | |
| Resonance frequency | 400 to 700 Hz |
| of spindle assembly 103 | |

It is required in Jpn. Pat. Appln. KOKAI Publication No. 2004-94989 that the resonance frequency (401 Hz) of the suspension 130 be made coincident with the resonance frequency (1.8 kHz) of the simplex disk 104. However, the slider 121 fluctuates around the protrusion 131 of the suspension 130, and hence there is the possibility of the leading edge 124a or the trailing edge 124b colliding with the disk surface if the resonance frequency of the suspension is used as the point of reference. As can be seen from Table 1, the resonance frequency of the suspension 130 is between the anti-resonance frequency (632 Hz) of the leading edge 124a and anti-resonance frequency (360 Hz) of the trailing edge 124b. Further, the disk 104 is screwed to the spindle motor 140 through the clamp ring 150, and when the external shock is applied thereto, the disk 104 is vibrated through the spindle assembly 103. Particularly, when the diameter of the disk 104 is 2.5 or 1.8 inches, the rigidity of the base 144 is small, and hence it is necessary to consider the resonance frequency not of the simplex disk 104 but of the overall spindle assembly 103 including the base 144. Furthermore, the resonance frequency of the simplex disk 104 is, from Table 1, 1.8 kHz, which is far larger than the resonance frequency of the suspension 130. In this case, although changing the thickness or outer diameter of the disk 104 is conceivable, these items cannot be set arbitrarily. Further, (1) changing the material or shape for the rigidity (spring constant of the load beam) of the hinge section of the suspension 130, and (2) changing the mass of the slider 121 are also conceivable. However, in the method of (1), there is the possibility of the flotation stability of the slider 121 being deteriorated. Further, the slider is selected from the limited sizes, and in the method of (2), the degree of freedom is low. From the above description, it is practically impossible to make both the resonance frequencies coincident with each other as required in Jpn. Pat. Appln. KOKAI Publication No. 2004-94989.

Conversely, this embodiment is characterized in that the resonance frequency of the spindle assembly 103 is made to be within the range of 5% of the anti-resonance frequency of the trailing edge 124b. The reason for employing not the resonance frequency of the suspension but the anti-resonance frequency of the “trailing edge 124b” unlike Jpn. Pat. Appln. KOKAI Publication No. 2004-94989 will be described below. In general, the air film rigidity of the trailing edge 124b is higher than that of the leading edge 124a, and hence if the flying height of the trailing edge 124b does not change, flotation of the slider is stable, and even if the leading edge 124a rises abruptly from the disk, there is little possibility of the leading edge 124a coming into contact with the disk 104 at the landing time. Conversely, even when the flying height of the leading edge 124a does not change, if the flying height of the trailing edge 124b changes even a little, the possibility of the flotation stability being lost, and the slider 121 coming into contact with the disk 104 becomes strong. In the present patent, the resonance frequency of the spindle assembly is made coincident with the anti-resonance frequency of the “trailing edge 124b”, and the flying height of the trailing edge 124b is prevented from changing, whereby the slider 121 is prevented from coming into contact with the disk 104. Conversely, in general, the resonance frequency of the suspension described in Jpn. Pat. Appln. KOKAI Publication No. 2004-94989 is a frequency substantially in the middle between the anti-resonance frequency of the trailing edge 124b and anti-resonance frequency of the leading edge 124a, further the trailing edge 124b rises abruptly from the disk 104 depending on the direction of the shock, and hence the shock-resistant capability of the suspension is inferior to that of the present patent. By making the anti-resonance frequency of the trailing edge 124b substantially coincident with the resonance frequency of the spindle assembly 103, it is possible for the slider 121 to exert the external shock-resistant capability thereof from the moment immediately after the slider 121 is introduced onto the disk 104.

From Table 1, the resonance frequency F of the spindle assembly 103 is normally, for example, about 360 Hz in the range from 400 to 700 Hz. Further, the range of 5% of the anti-resonance frequency of the trailing edge 124b is, for example, about 340 Hz to about 380 Hz.

When the anti-resonance frequency of the slider 121 is to be adjusted, (3) changing the size of the slider 121 is conceivable in addition to the methods of (1) and (2) described above. Examples of changing the size include selecting the size from, for example, the long femto type, femto type, pico type, and the like. The long femto type has a length L, width W, and depth H of 0.85 mm≦L≦1.85 mm, W=0.70 mm, and H=0.23 mm. The femto type has a length L, width W, and depth H of 0.85, 0.70, and 0.23 mm, respectively. The pico type has a length L, width W, and depth H of 1.25, 1.0, and 0.3 mm, respectively. In the case of the long femto type, the degree of freedom of selection of the length is high.

In order to adjust the resonance frequency of the spindle assembly 103, (1) changing the thickness or outer diameter of the disk 104, (2) changing the diameter of the clamp ring 150, (3) changing the diameter of the spacer 105, (4) changing the rigidity (the thickness of the thrust plate 147, and diameter of the groove 143a) of the bearing, and (5) changing the rigidity of the bracket (base) 144 (adding a rib in the direction perpendicular to the spindle 141, or changing the thickness in the direction of the spindle 141) are conceivable. Regarding the above, as described previously, in the method of (1), it is difficult to arbitrarily set the thickness or outer diameter of the disk 104. Accordingly, the methods of (2) to (5) are effective. Particularly, in the method of (4), the degree of freedom of change is high, and the degree of freedom of change in the method of (2) or (3) is secondly high. In each of the methods of (1) to (5), when each parameter is changed to a lager value, the resonance frequency becomes higher. In this embodiment, by appropriately combining the parameters of the methods of (2), (3), and (5) with the parameter of the method of (4), the resonance frequency of the spindle assembly 103 is lowered to the range of 5% of the anti-resonance frequency of the trailing edge 124b, for example, about 340 Hz to about 380 Hz.

Although the graph shown in FIG. 7 is hardly subject to the influence of the temperature, the resonance frequency of the spindle assembly 103 varies depending on the temperature. Accordingly, it is desirable that relationship 1 be satisfied at room temperature (23° C.) at which the magnetic disk apparatus is normally used.

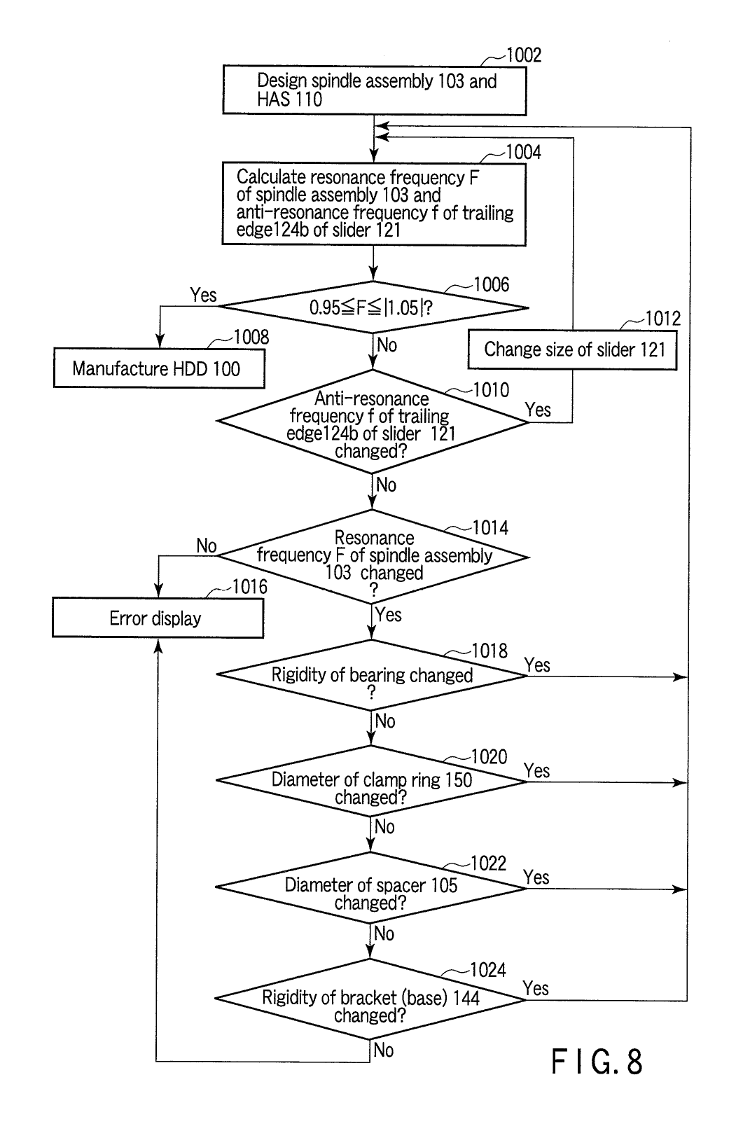

FIG. 8 is a flowchart for explaining a design method of the HDD 100. The design method of the HDD 100 shown in FIG. 8 is concretized as, for example, a computer program.

First, the spindle assembly 103 and HSA 110 are designed (block 1002). It should be noted that in block 1002, the design not of the HAS 110, but of the head gimbal assembly (HGA) obtained by removing the carriage 132 from the HAS 110 may be carried out. Then, the resonance frequency F of the spindle assembly 103, and anti-resonance frequency f of the trailing edge 124b of the slider 121 are calculated (block 1004). Then, it is determined whether or not relationship 1 (0.95f≦F≦1.05f) is established (block 1006). When it is determined that relationship 1 is established (block 1006), manufacture of the HDD 100 is started (block 1008).

On the other hand, when it is determined that relationship 1 is not established (block 1006), it is further determined whether or not the anti-resonance frequency f of the trailing edge 124b of the slider 121 is to be changed (block 1010). When it is determined that the anti-resonance frequency f of the trailing edge 124b of the slider 121 is to be changed (block 1010), the size of the slider 121 is changed (block 1012). Thereafter, the flow is returned to block 1004.

When it is determined that the anti-resonance frequency f of the trailing edge 124b of the slider 121 is not to be changed (block 1010), it is further determined whether or not the resonance frequency F of the spindle assembly 103 is to be changed (block 1014). When it is determined that the resonance frequency F of the spindle assembly 103 is not to be changed (block 1014), error display indicating that relationship 1 cannot be satisfied is carried out.

On the other hand, when it is determined that the resonance frequency F of the spindle assembly 103 is to be changed (block 1014), changing of the rigidity of the bearing (block 1018), changing the diameter of the clamp ring 150 (block 1020), changing the diameter of the spacer 105 (block 1022), or changing the rigidity of the bracket (base) 144 (block 1024) is carried out. When one of the above blocks has been carried out, the flow is returned to block 1004, and when none of the above blocks has been carried out, the error display of block 1016 is carried out.

In the operation of the HDD 100, even when an external shock is applied to the housing 102 from the moment immediately after the slider 121 is introduced from the ramp 160 onto the disk 104, the slider 121 follows up the displacement of the disk 104, and hence it becomes hard for the slider 121 to collide with the disk 104.

The airflow AF concomitant with the rotation of the disk 104 is entangled in the gap between the slider 121 and disk 104, thereby forming a minute air film, and lift configured to float the slider 121 over the disk surface acts on the slider 121. On the other hand, the suspension 130 applies elastic pressure to the slider 121 in a direction opposed to the lift of the slider 121 through the protrusion 131. The magnetic head section 120 and disk 104 is separated from each other with a constant gap maintained between them by the balance between the lift and elastic force.

Subsequently, the carriage 132 rotates around the pivot 134, and head 122 seeks to a position on the target track of the disk 104. At the write time, data obtained from the host such as a PC (not shown) or the like is modulated and amplified, and thereafter the data is supplied to the inductive head as a write current. As a result of this, the inductive head writes the data to the target track. At the read time, a sense current is supplied to the MR head, and data is read from the track of the disk 104. The read data is amplified and demodulated, and is then sent to the host (not shown).

According to the present embodiment, it is possible to provide a storage device in which, when an external shock is applied to the housing, a collision between the slider and disk is effectively reduced or prevented, and design method of the storage device.

While certain embodiments of the invention have been described, these embodiments have been presented by way of example only, and are not intended to limit the scope of the invention. Indeed, the novel methods and systems described herein may be embodied in a variety of other forms. Furthermore, various omissions, substitutions and changes in the form of the methods and systems described herein may be made without departing from the spirit of the invention. The accompanying claims and their equivalents are intended to cover such forms or modifications as would fall within the scope and spirit of the invention.

What is claimed is:

1. A storage device comprising:
a spindle assembly comprising a spindle motor configured to rotate a disk, and a clamp ring configured to attach the disk to the spindle motor; and
a slider with a head configured to read data from the disk and to write data on the disk, and configured to fly over a surface of the rotating disk,
wherein the slider comprises a trailing edge on a floating surface of the slider facing the disk, the trailing edge being an end portion configured to exhaust an airflow, and
the spindle assembly is configured to satisfy a relationship of 0.95f≦F≦1.05f substantially at a temperature of 23° C., where f is an anti-resonance frequency of the trailing edge, and F is a resonance frequency of the spindle assembly.

2. A design method of a storage device comprising a spindle assembly comprising a spindle motor configured to rotate a disk and a clamp ring configured to fix the disk to the spindle motor, and a slider with a head configured to read data from the disk and to write data on the disk, the slider configured to fly over a surface of the rotating disk, the design method comprising:
adjusting a rigidity of a bearing of the spindle assembly in order to satisfy a relationship of 0.95f≦F≦1.05f substantially at a temperature of 23° C., where f is an anti-resonance frequency of a trailing edge on a floating surface of the slider facing the disk which is an end portion configured to exhaust an airflow, and F is a resonance frequency of the spindle assembly.

3. The design method of claim 2, further comprising adjusting a diameter of the clamp ring.

4. The design method of claim 2, further comprising changing a diameter of a spacer between two disks next to each other and configured to maintain a gap between the two disks.

5. The design method of claim 2, further comprising changing a rigidity of a base as a supporting portion of the spindle motor.

6. The design method of claim 2, further comprising changing a size of the slider.
